(19) United States
(12) Patent Application Publication
(10) Pub. No.: US 2023/0237433 A1
(43) Pub. Date: Jul. 27, 2023

(54) Systems and Methods to Improve the Efficiency of Collaboration to Define and Establish Research Projects

(71) Applicant: Collavidence Inc., Calgary (CA)

(72) Inventors: Mayank GOYAL, Calgary (CA); Arnuv MAYANK, Calgary (CA); Rosalie MCDONOUGH, Calgary (CA); Johanna OSPEL, Calgary (CA)

(73) Assignee: Collavidence Inc., Calgary (CA)

(21) Appl. No.: 18/157,378

(22) Filed: Jan. 20, 2023

Related U.S. Application Data
(60) Provisional application No. 63/302,362, filed on Jan. 24, 2022.

(51) Int. Cl. G06Q 10/10; G06Q 30/0279

(52) U.S. Cl. CPC G06Q 10/103; G06Q 30/0279

(57) ABSTRACT

The invention relates generally to increasing the efficiency of knowledge sharing promoting research and innovation, and more specifically to increasing the efficiency of knowledge sharing and collaboration between participants/experts in particular fields. In particular, a system is described that supports each of a discussion group, working group and research group, wherein modules supporting each group has particular functionality to enable people discuss and define new problems, begin working together to advance collaboration to solve a problem and to assist in establishing a real-world research project.

### RELATED APPLICATIONS

This nonprovisional U.S. patent application claims the benefit of priority of U.S. Provisional Patent Application No. 63/302,362, filed Jan. 24, 2022, listing Mayank GOYAL as the first inventor and Collavidence Inc. as the applicant. The entire contents of the above-referenced application and of all priority documents referenced in the Application Data Sheet filed herewith are hereby incorporated by reference for all purposes.

### FIELD

The invention relates generally to increasing the efficiency of knowledge sharing promoting research and innovation, and more specifically to increasing the efficiency of knowledge sharing and collaboration between participants/experts in particular fields. In particular, a system is described that supports each of a discussion group, working group and research group, wherein modules supporting each group have particular functionality to enable people discuss and define new problems, begin working together to advance collaboration to solve a problem and to assist in establishing a real-world research project. The system is particularly tailored to help the transition from a loose or preliminary discussion to a focused research project with defined goals, and is especially suited to the advancement of medical research.

### BACKGROUND

It is well known that medical research undertaken to evaluate new treatments, drugs and/or medical devices, moves forward through a combination of basic research (e.g. lab research that involves cell culture and animal experiments) and clinical trials (e.g. research that involves human participants). Typically, following the basic research, a researcher or team of researchers will undertake additional clinical research in order to evaluate the results of the basic research to prove the safety of the treatment, drug and/or medical device in humans.

As is known and generally speaking, the stages of clinical medical research include a) observation of a particular pattern in clinical practice in single patients (anecdotal evidence) b) systematic observation of this pattern in a dataset that may have been collected and maintained over a period of time, c) establishing a hypothesis, d) designing a study, typically either a retrospective (e.g. a case series study) or a prospective (e.g. a cohort study) study and e) the use of data that are obtained to make further observations. In the case of a new treatment, once there is accumulation of sufficient data and relative maturity of technology and/or medications, trials are undertaken.

In the case of medical research that is seeking to prove the safety of a treatment, drug and/or medical device, such research will require that the clinical research is completed in stages, typically classified into phases (e.g. Food and Drug Administration (FDA) trial phases I, II and III) depending on whether the required work is early in the clinical research or relatively late in the research. Typically, Phase I trials are done in healthy volunteers to demonstrate safety, Phase II trials are done in patients to demonstrate feasibility, effect size and finally Phase III studies are done in patients that are usually Randomized Controlled Trials where the new treatment is tested head-to-head against the old approach to demonstrate benefit to patients.

Most clinical medical research studies are multi-centric meaning that more than one medical facility is involved and that can involve the participations of multiple teams, researchers, physicians and patients. Such studies have multiple advantages including faster accumulation of information especially for rare conditions, a greater degree of generalizability, robustness and overall greater credibility of the research. It is also well known that undertaking and completing such trials requires significant time and money.

In most cases, the process of receiving the money required to undertake both basic medical research and clinical medical research (clinical trials) involves one or more researchers to write various research grant applications to funding agencies. Many of these funding agencies are government agencies that utilize tax dollars to fund the research. One example in the United States is the National Institutes of Health (NIH). Other countries have similar national research funding agencies.

Alternatively, or in combination, private companies such as the company that manufactures a drug or device funds the medical research and/or medical trial (“industry funding”).

Still further, philanthropic agencies, such as the Bill and Melinda Gates foundation, may also fund research that may be of particular interest to that foundation.

The process of initiating medical research (both basic and clinical) is slow for multiple reasons. Sometimes it is so slow that, by the time a research grant has been granted, the study that it was supposed to be used for is already outdated because newer and better treatment options for that particular disease have become available. Some of the reasons that slow down the funding process are outlined below.

Generally, the demand for funding by researchers far outstrips the available supply of public and private funds for the research. This means that more often than not, a research grant application is rejected at the first submission, and multiple submissions are required until the application is eventually successful, leading to a substantial time delay. Moreover, the general trend of the competitiveness for funding continues to increase.

In addition, most funding agencies have a complex process of application, review and funding. These will often include fixed dates for submission (often only twice per year), complex submission formats and a slow evaluation process (often several months). With many agencies, once grant applications have been submitted, they are typically vetted by experts in the field via a condensed and intensive process where the experts travel to a central location where they may spend several days discussing and approving or denying grants. With other agencies, proposals are sent electronically to the experts for review. In either scenario, reviewers are academic peers volunteering their free time and performing the reviews besides their daily work, which may lead to time delays.

Importantly, while the grant reviewers are typically experts within their specific field, given the complexity of the various fields of research including medicine in general, they may not precisely have the expertise in the exact topic of a particular grant.

Under typical circumstances, the time from the submission of the first grant application to the grant being accepted is very often more than 2 years. Moreover, subsequent to a grant being approved, there are often various complexities related to budgets, and release of monies that can delay and/or affect the start of a research project.

In addition, and following grant approval, a further complicating step of medical clinical research is getting the various participating centers formally engaged to participate in the research. This has two critical steps including a) having one or more legal contracts related to the obligations of the principal investigators running the research/trials and the center wanting to participate in the trial and b) establishing and involving Institutional Review Boards (IRBs) that every major center is expected to have to provide guidance and permissions related to the ethical aspects of the medical trials.

As the above steps involves lawyers on both sides as well as boards that operate within fixed timeframes, these steps can also be time consuming.

Still further, for industry funded trials there are several additional considerations. For example, a company will primarily assign research funding to trials, that, if successful would increase the sales of the particular drug/device in question. If a business case cannot be made by the researchers, it is quite difficult to obtain industry funding.

Also, research that is heavily funded by industry may be perceived as biased by the public, and researchers who run industry-funded trials may under some circumstances risk their credibility. There is also data to suggest that industry-sponsored clinical medical research is indeed often biased towards favoring the new drug or device being tested.

Furthermore, clinical trials testing treatments with which no revenue can be generated by industry, for example, simple treatments such as daily exercise, physiotherapy or cold compresses, will not receive industry funding. In other words, industry funding will neglect simple, cheap treatments and often favor more expensive drugs and medical procedures from which revenue can potentially be derived.

In addition, company/industry sponsored trials are often designed and conducted in such a way that if successful, the research results in Food and Drug Administration (FDA) approval of a particular device or drug. Any involvement of the FDA adds further complexity to the process.

Generally, the FDA wants ‘pure’ data related to a particular device before granting approval. While this is desirable in some respects to the extent that one does not want to mix the results of two disparate drugs and devices and grant approval to both. However, on the other hand, if the results of the two are quite similar, one does not want to delay the whole approval process just because the individual companies lack sufficient commitment and/or resources to do only one drug/device trial. This is ultimately important to the extent that the patient may not necessarily care.

Very often from a patient point of view and/or from a clinical medical research point of view, the more important question is whether a particular procedure (as opposed to a particular device, which is only a small part of the entire procedure) is beneficial. For example, when performing a surgery for colon cancer, the patient and researcher is interested in whether the surgery as a whole is beneficial to the patient, not whether a particular scalpel is better than another scalpel.

In many cases, for the same procedure, more than one such device may be available that is manufactured by industry competitors. In these cases, industry finds it very difficult in a short period of time to find a way to work together to collectively move the science and the field forward such that if the trial is funded by one company, they often impose restrictions to the use of only their product in the trial.

Other implications of a slow and/or inefficient research process relates to the effect on the business case for the research. Generally, innovation is guided by the ‘business case’ and the overall costs of taking an idea to approval, sale and revenue generation. The longer and more time consuming this process is, the lower is the motivation for innovators, venture capital etc.

Rising costs are also a significant factor in affecting business decisions around undertaking research. Ultimately, the company manufacturing a drug/device has to make profit for the whole industry model to be sustainable. The longer the whole process takes, the higher the cost will be after the drug or device is approved.

Patient harm or lack of patient benefit is also a factor where certain harmful procedures/drugs may continue to be used in the absence of well conducted research. For example, giving high dose steroids for spinal cord injury is known to have a negative affect from several high-quality clinical trials, notwithstanding earlier research suggesting its benefit. Also, certain drugs/drug treatments that could have benefit may not be used for years for the want of adequate trial data.

Generally speaking, it is known that the involvement of a larger pool of opinions and views in considering a problem is more likely to reach a “best solution” as compared to the same problem being considered by a smaller group that may spend more time considering the same problem. That is, in a similar way that research results from a larger data set from multiple centers provides greater credibility and generalizability to the results, the opinions and views of a larger pool is more likely to reach the “best solution”. In addition, having access to a wider pool of opinions can result in greater efficiency in obtaining a best solution. That is, it is known that if an individual has a particular question or issue that they do not have an answer to, posing that question on an internet forum can quickly and efficiently provide an answer to that question as the question may be considered by individuals who may be experts in the field of the question and/or who may provide validation to the answer provided by others thus promoting the legitimacy of an answer.

In view of the foregoing, there has been a need for systems and processes that generally enable greater efficiency in the overall process of initially identifying and defining problems and thereafter reviewing the merits of various projects including medical research projects. In particular, there has been a need for the ability for a wider pool of participants/experts to consider and evaluate research projects within a forum that enables critical evaluation and involvement of those participants/experts in the review and validation of those projects and research funding allocation.

Furthermore, there has been a need for an efficient and iterative process that allows a pool of participants/experts to assist in contributing to the design and improvement of a particular research project. That is, in most cases, the grant application process is one-way in that the agency either says yes or no with regards to approval. An in-between way in the sense of conditional acceptance (“we think XYZ is a major flaw but if you address this adequately, we will accept the grant application”) generally does not exist. There is also little, if any, opportunity to provide constructive feedback. If feedback gets incorporated, it is only after a project gets rejected prior to the next grant application submission.

As such, there has been a need for systems and methods that allow for a dynamic two-way interaction between a principal investigator, participants/experts and funding groups that can more efficiently enable iterative feedback and discussions to occur that have the objective of improving the design of the study.

Further still, there has been a need for systems and methods that can more efficiently bring a more divergent or broader scope of expertise and opinions together. That is, with some studies there may be various issues related to systems of care, geography, ethnic variability of disease etc. For example, a researcher coordinating a multi-center study from within the United States may not foresee local practical problems in trial execution that may occur in India, South America or Eastern Europe, and may thus benefit from a broader perspective when considering and designing a study.

In another aspect, and in the same context, there has been need for systems and processes that enable greater efficiency in the collaboration of participants/experts to consider, discuss and propose solutions to various problems in other, non-medical areas of study. For example, collaboration in essentially all areas of technical or scientific study, artistic study, political study etc. would benefit from systems that likewise improve the efficiency of collaboration when seeking solutions to various problems. Such systems may also be used for the benefit of teaching and involving students in the process of collaboration and iterative learning.

In particular, collaboration between researchers for medical research projects can be difficult and inefficient to get started.

For example, one problem is identifying that a medical problem exists. Often, one physician will have anecdotal data or a hunch that there is something unusual or new that they have observed. However, they may have no preliminary theory to explain this occurrence, as well as an inability to know if other physicians around the world have observed the same phenomenon. This leads to another problem, which is that it is substantially impossible for different people who have related observations to recognize that they should connect, let alone actually connect. Without a system of global interconnectedness, there is no way for these ideas to be exchanged. Furthermore, researchers can have their own pieces of data that, on their own, may seem like meaningless coincidences, but when combined in the context of a larger dataset, may reveal a statistically significant and clinically meaningful pattern. Without a way of combining the observations of many researchers, these data, which may be a key aspect of a major finding, will never be used.

Furthermore, a lack of systems and methods that enable collaboration among medical researchers makes it difficult to start discussions and including others into a group to collectively ideate and compare and discuss findings. For example, lack of uncomplicated and safe ways to share data, competing interests and unclarity about authorship of future publications and merit may complicate collaboration even in the earliest stages of the project, where one would expect the future to be uncertain.

Further still, even if physicians who have observed similar disease patterns/cases have managed to connect and discuss their findings, there is another major obstacle, namely the transition from a loose, general and rather vague discussion of anecdotal evidence to a clearly defined study that systematically investigates the discussed disease/phenomenon. This is a common point of failure where some researchers simply do not manage to translate the knowledge gained from their single observations into a structured study framework.

Even if transition has been successful, the current process of medical research is also haphazard and unstructured in its inception and completion. There is usually no detailed project timeline with milestones, progress reports and mechanisms to ensure that each research team member fulfills their individual responsibilities. Projects are often started with insufficient prior due diligence and discussion. On the flip side, ideas that may be worthy of becoming projects cannot do so due to insufficient prior due diligence and discussion.

Projects often cannot be initiated due to an inability to gain funding. Further, projects often fail or cannot be initiated due to the lack of a team with the necessary diversity of skillsets to effectively execute the project, even if funding has successfully been obtained. All of these examples signal that a medical research project can fail easily at any point in the pipeline of a project's development, from the idea to a funded project. Thus, it is necessary for there to exist a unified system and associated methods to conduct this entire pipeline, as it will minimize the chances of or prevent unworthy and potentially harmful projects from being conducted, as well as enable worthy projects to overcome any of these issues and successfully run through the entire medical research pipeline all the way until the study is finished and the results of the study are published.

### SUMMARY OF THE INVENTION

Briefly, the invention is directed to a system and method for sharing knowledge amongst qualified users and particularly for transitioning from a preliminary discussion of anecdotal evidence to a more structured, formal research proposal and research group with certain tasks and responsibilities that are divided among the group members.

In a first aspect, a system for enhancing collaboration between users of an internet enabled website and/or application software allowing multiple users to interact with the website and/or application software is described, the system having: a computer system including at least one input system and at least one graphical output system, the computer operatively connected to the internet and including non-transitory computer readable medium encoded with instructions configured as: a discussion group module enabling creation of a discussion group, the discussion group module enabling a user to input one or more questions to be answered to the input system and multiple additional users to access and provide answers to the one or more questions in a discussion forum; and, a working group module enabling transformation of the discussion group to a working group, the working group module enabling a working group leader to define a working group having at least one working group goal and to enable multiple additional users to become working group members and where criteria to join the working group requires authorization from the working group leader.

In one embodiment, criteria to transition a discussion group to a working group includes any one of or a combination of: a minimum time from a date of establishing a discussion group; a total number of discussion group posts; and, approval from a system moderator.

In another embodiment, the system further includes a research group module, the research group module enabling transformation of the working group to a research group, the research group module enabling a research group leader to define a research project having a defined hypothesis, methodology and budget and to enable multiple additional users to become research group members and where criteria to join the research group requires authorization from the research group leader.

In one embodiment, the criteria to transition a working group to a research group includes any one of or a combination of: a threshold number of working group data inputs to have been input into the working group module; a threshold number of observations to have been input into the working group module; a threshold number of working group members agreeing to establish a research group; approval from a system moderator.

In various embodiments, the research project is published for crowd review and crowd commenting on relative merits of the research project, crowd individuals can post comments to the research project, the research project is published for funding and/or the research group module enables crowd individuals to financially contribute to a research project.

In one embodiment, if the research project is published for funding and a funding goal is partially or fully-reached, the research project module publishes a funding status.

In further embodiments, if a research project is commenced, the research project module publishes a research project status as “underway”.

In one embodiment, the working group is defined as a medical-research working group and the working group module requires: input to identify a Principal Investigator (PI); input to identify working group members; background information input; input to define a working group hypothesis; and, input to define at least one working group goal, to establish the working group.

In various embodiments, a working group goal is defined as one or more of: conducting a systematic review of literature; retrospectively collecting cases from individual physician experiences; starting a prospective registry; and initiating discussion on whether a trial is possible.

In another embodiment, the research group is defined as a medical-research research group and the research group module requires: input to identify a research group Principal Investigator (PI); input to identify research group members; background information input; input to define a research group hypothesis and how the research group hypothesis will be tested; input to define required research group materials; input to define a research group project timeline; input to define a research group budget; and, input to define research group financial requirements; to establish the research group.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1 is a high-level overview of one embodiment of the invention showing the steps from an informal discussion group to a collaborative working group to hypothesis-driven research group, including requirements to continue at each transition point.

FIG. 2 is an overview of a user registration module of a project collaboration system in accordance with one embodiment of the invention.

FIG. 3 is an overview of a discussion group creation module of a project collaboration system in accordance with one embodiment of the invention.

FIG. 4 is an overview of a working group creation module of a project collaboration system in accordance with one embodiment of the invention.

FIG. 5 is an overview of a project communication module of a project collaboration system in accordance with one embodiment of the invention.

FIG. 6 is an overview of a research group creation module of a project collaboration system in accordance with one embodiment of the invention.

FIG. 7 is an overview of a project revenue module of a project collaboration system in accordance with one embodiment of the invention.

FIG. 8 is an overview of a project progress module of a project collaboration system in accordance with one embodiment of the invention.

### DETAILED DESCRIPTION OF THE INVENTION

All terms have definitions that are reasonably inferable from the drawings and description. Language used herein is to be interpreted to give as broad a meaning as is reasonable within the inventive concepts described herein.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

### Overview

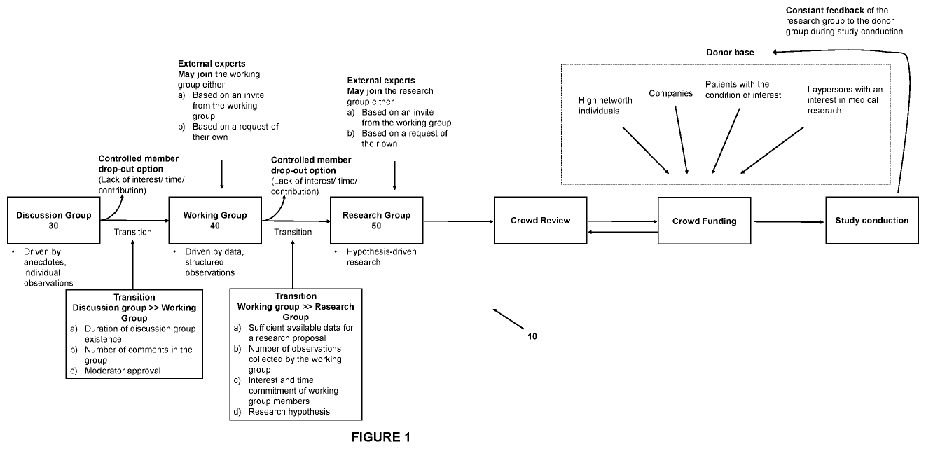

In accordance with the invention, systems and methods for enabling collaboration between parties is provided. As shown in FIG. 1, various parties can interact with a project collaboration system 10 to enable collaborative input to defined questions, problems, issues, projects, etc. through a series of modules that include and are configured as a discussion group module 30, working group module 40 and research group module 50.

As shown in FIG. 1, the system generally involves collaborating individuals to interact with a sequence of three modules, with filtration rules allowing the individuals to advance from each module to the next as various requirements are met. The modules are, in order, “Discussion Group” (30), “Working Group” (40), and “Research Group” (50). Each of these modules, as well as the interaction between other modules are described below. The system is generally deployed as an interactive web-based system, for example, as a website having an underlying web-application and/or web-based mobile device applications. The configuration and functionality of the system is described based on representative user interaction.

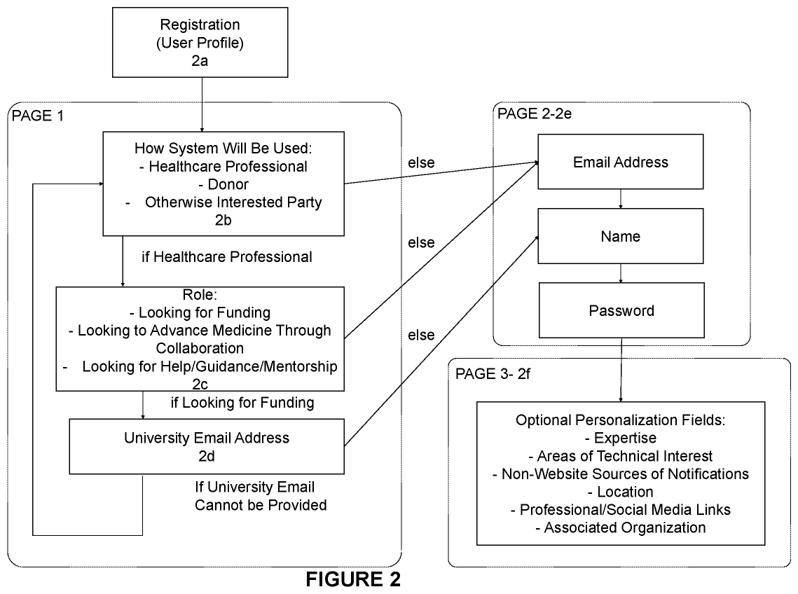

Initially, in order to access the system and/or upload content to the system, an individual can register and create a profile (FIG. 2) via a registration process 2a. To do so, in a typical embodiment, the individual is prompted with how they would like to use the system 2b, with the representative choices being 1) as a healthcare professional, 2) as a donor, or 3) as an otherwise interested party. If the user inputs 1), then they will be prompted to select a role 2c, with representative choices being 1) a healthcare professional looking for funding, 2) a healthcare professional looking to advance medicine through collaboration, or 3) a healthcare professional looking for help/guidance/mentorship. In one embodiment, as a means of providing security to the system and to minimize the risk of fraudulent projects being initiated, if the individual indicates they are looking for funding and inputs 1, then for example, they may be asked to confirm that they are affiliated with a university and have a university-associated email address 2d. The user will input a “Yes” or “No.” If the user inputs “No”, other requirements may be required before that user can legitimately register as an individual looking for funding.

Continuing, a typical next page 2e will require the user to input their name, email, and password for the account to be set up. If the user successfully completed the previous step as a healthcare professional looking for funding, they will not be required to enter an email address, as that information was collected in the previous step. Upon successful inputs, the user may be required to confirm their account on the email address that they inputted and doing so will result in the successful creation of an account in the system.

In some embodiments, the user will have the option, but not the obligation, to submit other fields to personalize their account 2f, page 3. Such fields may include, but are not limited to, 1) expertise, 2) areas of technical interest, 3) non-website sources of notifications, 4) location, 5) professional/social media links, and 6) associated organization. The user would have the option to alter this information at any point after creating the account.

### Discussion Group

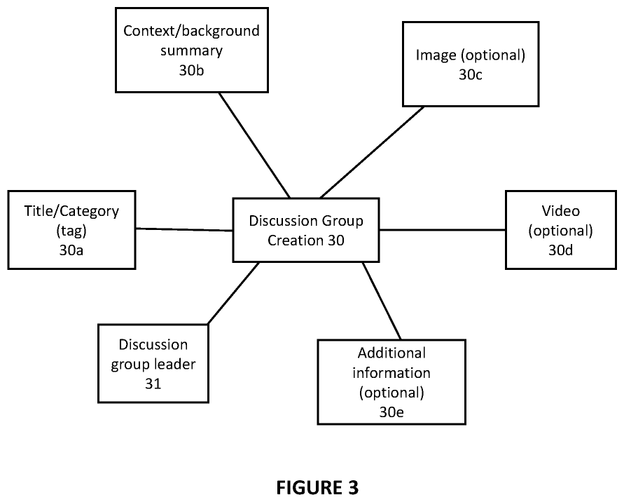

With the conclusion of the account creation, a user can move to construct a “Discussion Group,” which they will do using the discussion group creation module 30 as shown in FIG. 3. The discussion group creation module 30 requires the user (now a “Discussion group leader” 31 to submit information that may include a title and at least one category (tag) 30a that describes a new discussion group, and a summary of the context/background 30b of the discussion group. Users may also attach associated materials such as an image 30c, a video 30d, or additional information 30e. Upon successful completion and submission of all required elements, the user will have created a discussion group with their user profile.

The purpose of a discussion group is to initiate discussion among members of the system with pertinent experience about a certain topic. The discussion topics can, but not necessarily, relate to problem identification, comparison of experiences, and/or personal opinions. Once a discussion group has been created, other users may be able to then participate in the discussion group which has forum functionality.

An example of a discussion group is as follows: Participant A, a physician has thought about a clinical challenge of one or her patients with a giant wide-necked posterior inferior cerebellar artery (PICA) aneurysm. She knows these are relatively rare, representing 0.5-3% of all aneurysms and understands that there is a paucity of natural history data and a lack of consensus regarding treatment strategies. She then creates a Discussion Group around how she attempted to treat it and shares a complication that arose during the procedure. The question becomes “Are these complications common or uncommon? What are some personal experiences with this complication?”

Participant B, a non-medically trained person, after joining the discussion group, states that her relative had experienced the same complication, and that the physicians at the time were unaware of standard protocol.

Participant C, a physician, states that he had a similar complication of a related case.

Participant D, a physician, asks if the complication could have been avoided if A had done XYZ instead.

Participant E, a university researcher, asks about where he can find more information about this type of aneurysm.

Over the next month, several hundred members of the system comment on this discussion group, and the problem gains increasing traction in the eyes of the medical world and the general public. In this example, the purpose of the discussion group was not experimentation, but discussion. However, through the traction the discussion group had gained, as well as the variety of different opinions uncovered, Participant A realizes the relevance of the scenario and will likely look to conduct further investigation. To do so, she would convert her discussion group into a working group 40.

The conversion of a discussion group into a working group 40 requires the discussion group to achieve certain metrics on the system that signals the worthiness of the discussion group to graduate to a working group (FIG. 1).

The metrics may include, but are not limited to, any of the following: a) duration of group's existence, b) number of comments on the group, c) number of views of the group's page, d) group's rating, e) moderator approval. If these criteria are met, then the discussion group's initiator has the right, but not the obligation to convert the discussion group into a working group. If the initiator elects not to, other members of the system may request the initiator 31 to grant them leadership of the discussion group, allowing for a motivated individual to convert the discussion group to a working group. Regardless of whether the discussion group is converted to a working group or not, the discussion group may continue, and/or in some embodiments may be closed.

### Working Group

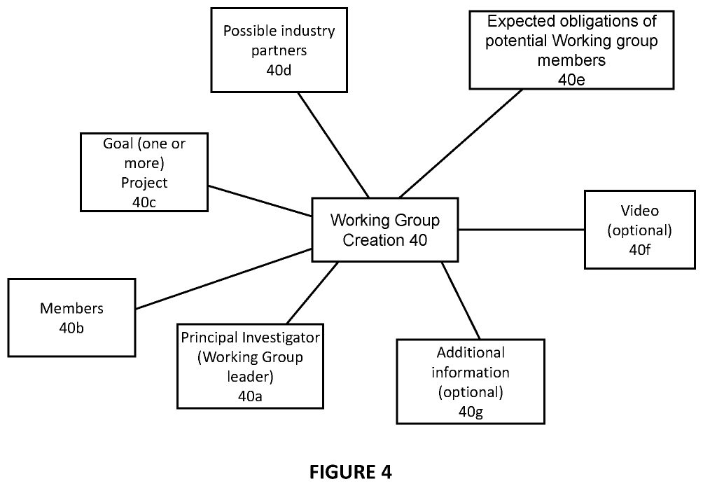

To convert the discussion group to a working group, the discussion group leader 31 inputs specifics for all required fields into the working group creation module 40 as shown in FIG. 4. This information includes identifying a PI (Principal Investigator) 40a, and/or Co-PI(s), members 40b, background information, a hypothesis, and at least one goal of the working group (with options 1) 40c.

For example, goal(s) may be described as, for example, conducting a systematic review of literature, retrospectively collecting cases from individual physician experiences, starting a prospective registry, initiating discussion on whether a trial is possible, and other goals. As such, goals are generally defined in terms of obtaining evidence to support a hypothesis.

In addition, a working group may also include identification of an actual or desired industry partner 40d and expected obligation(s) of people wishing to join the working group 40e. The working group module may also allow other information to be included 40f, 40g.

In various embodiments, the system will enable/require specific data to uploaded to specific fields such as specifically defining the role of an industry partner. Upon successful completion and submission of all required elements, the leader will have created a working group.

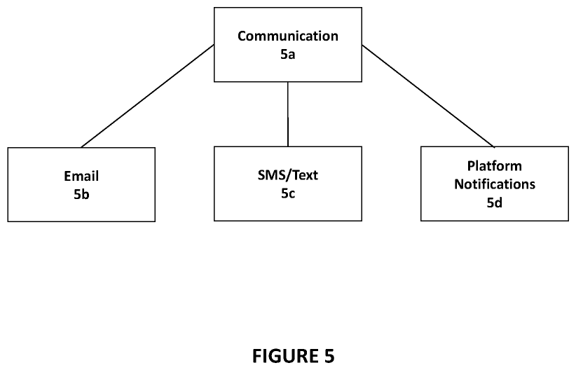

Once the discussion group leader has successfully started a working group and becomes the working group leader, the group becomes visible to all users of the system. New prospective members can request to join said working group via working group page or can be invited to the group by the working group leader. In one embodiment, the application to join a working group will not require any further input; however, some embodiments may require more details about the applicants' expertise, interests, etc. The working group leader will then receive a notification (via the platform for example, via email 5b, SMS 5c, or other choice of notification setting 5d as shown in FIG. 5) that an individual has requested to join their working group, with the request including a link to the user's profile.

If the working group leader approves the request, then the member is officially a member of the working group. If the working group leader does not approve the request, then the requesting user is notified via their choice of notification setting.

The purpose of a working group is to work towards the stated goals and to distribute work and receive input from the members. The working group will function to generally distribute/combine the work to/from members wherein the input/experience of all the members of the group works towards the goal. This can include coming up with background work, collection of information/data that can lead to statistically meaningful results for a particular problem and/or provide a full framework to the issues relating to the problem/goal at hand.

The working group is generally expected to work based on data, rather than opinion. When someone posts, all members of the working group are notified. Participants have the option to reveal private email addresses/phone numbers for further communication/organization. In various embodiments, there is no formal input of background information, and participants can join (assuming permission is granted) and leave the working group as they choose.

The leader can define the amount of participation required to become a member and this will, in some embodiments of the system, determine the automatic removal of non-participating members in the future. An example of such a working group scenario continues with the example of the clinical challenge of a patient with a giant wide-necked PICA aneurysm.

As introduced above, Participant A has converted her active discussion group into a working group, where the initial point of discussion was a case of a giant PICA aneurysm that she treated with a stent and coils. Unlike the discussion group, she now wants to find out what other physicians are doing in this rare scenario, to better understand the pros and cons of differing approaches. The question becomes “What is the natural history of giant PICA aneurysms and what is the best treatment strategy?”.

To this end, the working group is specified to have the goal of setting up a registry of patients with giant PICA aneurysms and long-term follow up. For people to join her working group, she requests that they have treated at least one patient with a giant wide-necked PICA aneurysm and/or have research/engineering experience in aneurysm treatment/equipment.

Participant F has treated multiple such patients and requests to join. Participant A agrees and unlocks the group for him. Other participants are also selectively approved to join the working group.

Participant G posts on the discussion, asking why she didn't use a Flow Diverter, highlighting the relative pros and cons to the stent/coil approach.

Participants G-K subsequently join the working group, discussing the pros and cons of both approaches, while Participant L recommends a surgical approach with which she has been successful.

Participant M states that his hospital had been keeping track of such cases for several years and states the availability of a small dataset containing the outcomes.

Participant N is an engineer working for a stent company who has been designing various stents for many years and is interested in the topic.

In this example, the purpose of the working group is to lead to a retrospective/prospective study of cases collected by participants and design a strategy for a clinical trial. This would require an amalgamated dataset and funding, but the working group has already established a strong team and working hypothesis. Thus, the working group would look to transition to a research group 50.

In various embodiments, the system is configured such that the discussion group and working group are a single module wherein discussion group functionality is incorporated into the functionality of a working group module. This approach may be employed depending on the initial status of a particular question. That is, in some scenarios, separate progression between a discussion group and working group may not be required.

### Research Group 50

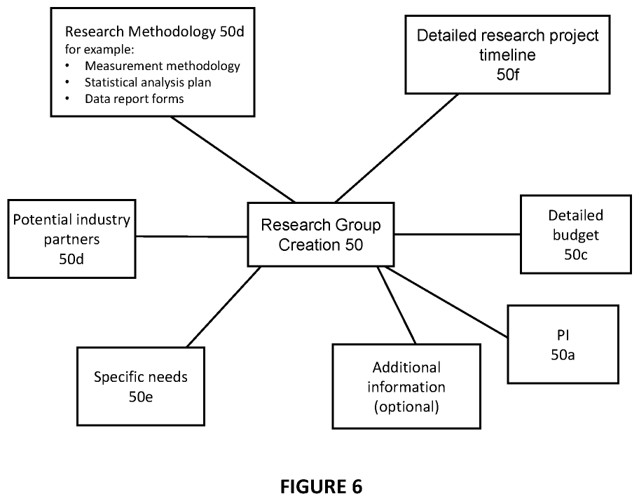

The purpose of a research group is to take the working hypothesis formed in the working group and create an actionable plan/strategy on how to test the hypothesis through experimentation. Initially, the leader of the research group (generally referred to herein as a principal investigator PI 50a, FIG. 6 or sponsor) creates a research project for which they wish to have reviewed for the primary objectives of obtaining private and/or government funding to complete. The research project may have a fundamental commercial objective or may have a basic non-commercial objective.

For example, in the case of a project having a commercial objective, the PI may be an orthopedic surgeon who wishes to evaluate and potentially develop a new hip replacement implant. The scope of the project requires both basic research in the design and engineering of the proposed implant, basic laboratory and non-clinical research to evaluate the engineered design and non-clinical questions of the implant, and thereafter, if the basic research is successful, a full clinical evaluation of the implant across multiple centers for the ultimate objective of full commercialization of the proposed device.

The leader will define the amount of participation required to become a member and this will, in some embodiments of the system, determine the automatic removal of non-participating members in the future. As above, participants have the option to reveal private email addresses/phone numbers and selected means for further communication. There is no formal input of background information, and participants can join (assuming permission is granted) and leave the research group as they choose.

To convert from a working group to a research group, the PI prepares and uploads a detailed methodology 50b on how the hypothesis generated in the working group phase will be tested, including materials and timelines 50f. In addition, the PI specifies a detailed budget 50c with a final “ask” for the amount of money needed to conduct the research. The PI also specifies if they have any commercial or industry partners 50d in their endeavor. Further, the research group PI can identify specific “needs” 50e required to complete the project, e.g., statistics help, scientific writing help, ethics help. These “needs” can be adjusted/updated as the research group project progresses and will be searchable on the system for potential collaborators who can fulfil these “needs”. These fields will all be submitted into the research group module 50 as shown in FIG. 6.

Once the PI has submitted the research group's proposal, the project will be published/available on the system for other uses to view and potentially provide feedback and funding. In some embodiments, feedback will be in the form of comments/comment threads, and in other embodiments, both the project and the comments have a rating system to ensure that the “best” projects and most useful comments gather the most attention. When someone posts, all members of the research group are notified.

Once the working group leader has successfully started a research group, all members of the working group are automatically transferred to the research group as team members and the research group becomes visible to all users of the system. New prospective members can request to join said research group via the research group page(s) and/or users can be invited to the group by the research group leader. Working group members may also leave the group.

In a typical embodiment, the application to join a research group will not require any further input; however, some embodiments may require more details about the applicants' expertise, interests, etc. The research group leader will then receive a notification that an individual has requested to join their research group, with the request including a link to the user's profile. If the research group leader approves the request, then the member is officially a member of the research group. If the research group leader does not approve the request, then the requesting user is notified.

Access to a legal module that may provide the legal implications and rules of using the site may be required depending on the type of project that is defined.

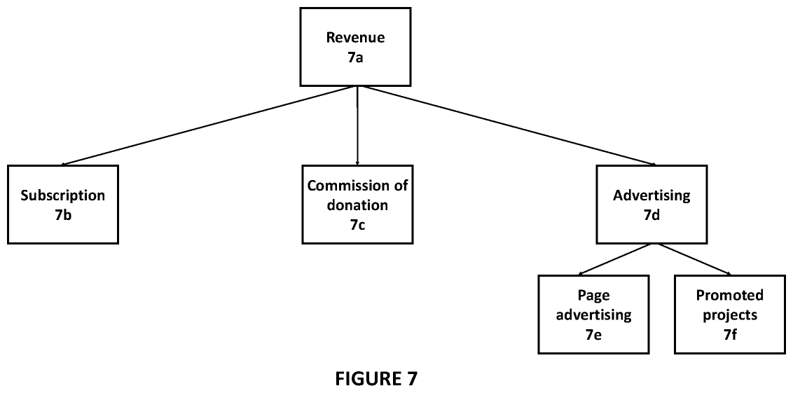

Further, in various embodiments, a user may be required to activate a subscription to enable their participation as shown in FIG. 7. Subscriptions 7b may be based on a number of models depending on the type of user. For example, project sponsors/PIs seeking technical collaboration or non-commercial funding may have no subscription fee whereas industry partners seeking funding for commercial projects may be required to pay an initial and/or ongoing fee as well as a commission 7c on funding pledged. Advertising revenue 7d may be derived from page advertising 7e and/or promoted projects 7f.

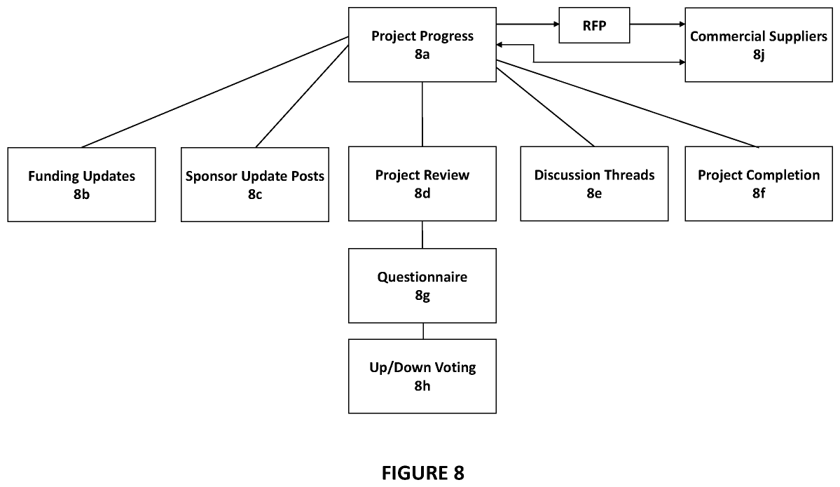

Once a research group has been created and is viewable on the system, other users of the system can interact with the research project including: 1) review the proposal and provide comments/suggestions, etc., and 2) fund the proposal. Members of the research group can opt to update their proposal based on the suggestions and comments left by the users in their review as shown in FIG. 8, 8e.

In some embodiments, the others users may be provided incentives to provide useful and constructive feedback. Members may also choose to update their proposal for other reasons, such as the inclusion of a new member that fills a need, a change in the amount of funding needed, or the broadening or focusing of the research topic. In this way, the research group's proposal will progress, and, accordingly, there will be ongoing review and funding updates (although funding may end once the project reaches its goal). The progress of a project may be tracked depending on the type of project that has been established as shown in FIG. 8. As can be appreciated, the system is intended to support many projects and the different types of projects simultaneously, such that the progress of the projects will be anywhere from newly created through to fully completed projects.

An example of a research group continues the example of the clinical challenge of a patient with a giant wide-necked PICA aneurysm.

Participant A converted her active discussion group into a working group, and now into a research group 50, where the initial point of discussion was a case of a giant PICA aneurysm that she treated with a stent and coils. Unlike the working group, she now wants to use the accumulated data from the working group to conduct a retrospective observational study comparing patient outcomes following endovascular versus surgical treatment. The question becomes “Which treatment strategy is superior with respect to procedural complications and patient outcomes?”.

To this end, the research group outlines a budget including research fellow fees, statistical software fees, database maintenance/data hosting fees, and other relevant expenses. In one embodiment, the project would generally have been defined within various technical areas including, for example, “medicine”, “aneurysm”, “endovascular treatment”, “neurology”, “neurosurgery”, “surgical technique”, etc.

Participant A and team realizes the limitations of the group's statistical proficiency and selects “statistics help” as a “need” upon creation of the research group.

Ultimately, and to the extent that the system, may be simultaneously hosting a number of projects relating to PICA aneurysms, the system seeks to enable appropriate users to review the various PICA aneurysm projects and provide both subjective and objective input on the merits of the various projects.

Ideally, however, the objective of the system is to more efficiently allow a greater number of reviewers to provide input regarding their opinion regarding the design of the project and/or the value and/or merit of a number of projects, such that funding agencies who may be contributing to the project will have a broader range and scopes of opinion regarding a number of related projects.

Importantly, the input received from a broader pool of reviewers may be highly effective in enabling more efficient decisions to be made to the extent that a smaller pool of “traditional” reviewers within a funding organization may grant significant weight to the collective opinion of a broader pool of experts. Thus, it is an objective that through the widespread implementation of the subject system, the speed and efficiency through which important funding decisions can be made can be significantly streamlined. Importantly, as can be appreciated, to the extent that large funding organizations who have significant overhead costs in running their organizations can draw on the wider and broader expertise of the internet, there is a significant potential to reduce the overhead costs associated with such organizations, such that a larger percentage of budgetary funds may be allocated to the research as opposed to the administrative costs of running the organization.

Research groups with a defined budget may provide a funding update 8b as a further means of providing real-world consideration as to the merits of a project. In addition, a sponsor may provide ongoing updates 8c regarding the project having regard to technical considerations, results and other project developments. Ongoing discussion threads 8e may form part of the project progress.

In the case of Participant A and team, following engagement of a statistician who aids in the statistical planning of the project, a “need” for help in scientific writing is realized and indicated on the research group project page. Further, an indication of project completion (or withdrawal) 8f may also be provided.

In one embodiment, the project collaboration module is also opened to commercial suppliers of products and services. That is, if authorized, a commercial supplier may be able to contact a PI to propose their involvement with a project for their commercial gain. In this regard, a PI may be able to access specific commercial expertise (and funding) that may be beneficial in the execution of the project. Such suppliers may include for example, companies having particular products or services required for the project including specific equipment or supplies.

In addition, such suppliers may include service providers such as law firms who may have particular expertise required for the project such as business law and/or intellectual property expertise.

In addition, when commercial suppliers may be involved, the PI may be able to utilize the system to efficiently establish business relationships with suppliers through a request for proposal (RFP) process from suppliers 8j. In some cases, such processes may be required by a funding agency to ensure funds are being efficiently spent.

In various embodiments, the system is implemented in a non-commercial format or, as introduced above in relation to FIG. 7, with a commercial format 7a requiring users to have subscriptions 7b to the system. In addition, the system may take a commission on the donations coming in 7c as well as allow advertising 7d in various forms including traditional page advertising 7e and/or promotion of particular projects 7f within the website by payment. For example, commercial suppliers will generally be able to purchase advertising with the system and/or may be required to have a subscription to the system and a PI may be able to promote their project at different levels of the website through payments.

Additional functionality of the system is described that may be implemented as well as other benefits and advantages in improving the efficiency of collaboration and research are listed:
The system is a web-based solution to enable a broad range of inputs from all geographical regions.
The system enables access to a wide range of participants potentially including in the case of medical research, physicians, trainees, nursing staff, healthcare administrators, representatives for ethics boards, representatives from relevant industry, representatives from funding agencies, representatives from payors and patients.
Working and research group submissions will preferably be limited in size utilizing standardized formats and a maximum number of words for various sections.
Back-end administration by a system administrator and organization of research group projects may be utilized to help facilitate users' interactions with the system and assist in moving different groups through the system.
Back-end administration may implement particular questionnaires/information common to a number of related projects that may assist users to understand the requirements to progress a group.
Users can search groups via several sorting mechanisms, including but not limited to “newest”, “highest interaction”, “highest rated” groups.
System can reduce likelihood of biases as compared to a traditional review process.
System promotes a broader field/range of collaboration.
System enables individuals to donate money towards a research group project. For example, if the budget of a trial is $1 million, this could be raised by small donations from individuals and/or interested groups.
System enables industry at any time to come in and show their financial support.
Fundraising organizations and patient advocate groups can provide financial support through targeted fund raising.
Individuals or corporations of high net worth can give targeted donations.
Conduct of trials and accountability of funds can be assisted through the system through the use of system auditors.
Other parties, including universities, can be involved to assist in funds accountability where appropriate.
Results and reporting can follow current systems.
System can enable dramatic speeding up of research review and grant process.
Involvement of a larger pool of people arguing and criticizing a project is more likely to yield a higher quality proposal/result.
The system may not have a fixed denominator of funds (unlike a typical funding agency).
If the community at large likes more than one proposal both or more can be funded.
A web-based solution can provide a mechanism for industry partners to work with each other.
No geographical barriers (e.g., a person from China can comment on a proposal from Seattle).
System can potentially free up traditional funding agencies like NIH to fund research that is more long term, felt to be very important but does not have popular support, research on rare conditions, research of massive scale (that may be beyond the capacity of the contributing individuals or industry.
Projects may be linked to a specific charitable organization. For example, one charitable organization (Heart and Stroke Foundation) can list a number of projects and allow donors to select and/or evaluate the specific project they wish to support through a financial contribution. That is, when a donor wishes to make a contribution, they may be able to make a general contribution that is not targeted to any particular project, or they may be prompted to review and/or identify a project that they wish to specifically support.
Projects are not limited to medical projects and could involve other projects in other scientific or artistic disciplines.
A PI can send invites to friends/colleagues with a project ID number, QR code and/or link as a means of inviting them to participate in the project.
The system can collaborate with a number of different organizations including charitable organizations, professional bodies and/or granting agencies allowing such organizations through their websites to link to one another. For example, a splash page of the system website may have logo links to different organizations and such organizations can have links back to the system website thus allowing users to review projects on the system website but also interact with an organization's website.
The system could support sponsored prizes for research. For example, an organization may promote a project and set out a challenge to the world to solve. As such, the system can support the means by which people can collaborate on a global solution and/or create sub-projects within the main project that enable collaboration.

### Collateral Benefits

Problems that have no obvious champion and have no business case could also be solved this way.
A person from a developing region (e.g. sub-Saharan country) could bring up a question that is unique to that part of the world. At the same time everyone from across the world is free to provide solutions and research designs.
Many types of projects can be supported and benefit from the system, including big picture societal questions such as collaboration on questions of alternative energy, population control, women's education throughout the world, political issues, etc.

Although the present invention has been described and illustrated with respect to preferred embodiments and preferred uses thereof, it is not to be so limited since modifications and changes can be made therein which are within the full, intended scope of the invention as understood by those skilled in the art.

1. A system for enhancing collaboration between users of an internet enabled website and/or application software allowing multiple users to interact with the website and/or application software, the system comprising:
a computer system including at least one input system and at least one graphical output system, the computer operatively connected to the internet and including a non-transitory computer readable medium encoded with instructions configured with:
a discussion group module, the discussion group module configured to enable creation of a discussion group, the discussion group module enabling a user to input one or more questions to be answered to the input system and to enable multiple additional users to access and provide answers to the one or more questions in a discussion forum;
a working group module configured to enable transformation of the discussion group to a working group, the working group module configured to enable a working group leader to define a working group having at least one working group goal and to enable multiple additional users to become working group members and where criteria to join the working group requires authorization from the working group leader.

2. The system as in claim 1 where criteria to transition a discussion group to a working group includes any one of or a combination of:
a. a minimum time from a date of establishing a discussion group;
b. a total number of discussion group posts; and,
c. approval from a system moderator.

3. The system as in claim 1 further comprising a research group module, the research group module configured to enable transformation of the working group to a research group, the research group module configured to enable a research group leader to define a research project having a defined hypothesis, methodology and budget and to enable multiple additional users to become research group members and where criteria to join the research group requires authorization from the research group leader.

4. The system as in claim 3 wherein criteria to transition a working group to a research group includes any one of or a combination of:
a. a threshold number of working group data inputs to have been input into the working group module;
b. a threshold number of observations to have been input into the working group module;
c. a threshold number of working group members agreeing to establish a research group;
d. approval from a system moderator.

5. The system as in claim 4 wherein the computer system is configured to publish the research project for crowd review and crowd commenting on relative merits of the research project.

6. The system as in claim 5 wherein the computer system is configured to enable crowd individuals to post comments to the research project.

7. The system as in claim 5 wherein the computer system is configured to publish a research project for funding.

8. The system as in claim 7 wherein the computer system is configured to enable crowd individuals to financially contribute to a published research project.

9. The system as in claim 7 wherein the computer system is configured to publish a funding status of a research project and to display if a funding goal is partially or fully reached.

10. The system as in claim 3 wherein if a research project is commenced, the computer system is configured to display a research project status as “underway”.

11. The system as in claim 1 wherein the computer system is configured to define the working group as a medical-research working group and the working group module is configured to require:
a. input to identify a Principal Investigator (PI);
b. input to identify working group members;
c. background information input;
d. input to define a working group hypothesis; and,
e. input to define at least one working group goal
to establish the working group.

12. The system as in claim 11 wherein the computer system is configured to define a working group goal as one or more of:
a. conducting a systematic review of literature;
b. retrospectively collecting cases from individual physician experiences;
c. starting a prospective registry; and
d. initiating discussion on whether a trial is possible.

13. The system as in claim 11 wherein the computer system is configured to define the research group as a medical-research research group and the research group module requires:
a. input to identify a research group Principal Investigator (PI);
b. input to identify research group members;
c. background information input;
d. input to define a research group hypothesis and how the research group hypothesis will be tested;
e. input to define required research group materials;
f. input to define a research group project timeline;
g. input to define a research group budget; and,
h. input to define research group financial requirements;
to establish the research group.
